(19) United States
(12) Patent Application Publication
(10) Pub. No.: US 2019/0312538 A1
(43) Pub. Date: Oct. 10, 2019

(54) MOTOR CONTROL APPARATUS, SHEET CONVEYANCE APPARATUS, DOCUMENT FEEDING APPARATUS, DOCUMENT READING APPARATUS, AND IMAGE FORMING APPARATUS

(71) Applicant: CANON KABUSHIKI KAISHA, Tokyo (JP)

(72) Inventor: Takeyuki Suda, Nagareyama-shi (JP)

(21) Appl. No.: 16/374,604

(22) Filed: Apr. 3, 2019

(30) Foreign Application Priority Data
Apr. 9, 2018 (JP) 2018-074965

(51) Int. Cl. H02P 21/00; H02P 21/16; H02P 21/22; G03G 15/00

(52) U.S. Cl. CPC H02P 21/0021; G03G 15/6529; H02P 21/22; H02P 21/16

(57) ABSTRACT

A motor control apparatus includes a detector configured to detect a drive current, a phase determiner configured to determine a rotation phase of a rotor of a motor, and a controller provided with a first control mode for controlling the motor by controlling the drive current flowing in a winding of the motor so as to reduce a deviation between an instructed phase and the rotation phase, and a second control mode for controlling the motor based on a current having a predetermined magnitude. The controller decelerates the rotor after switching a control mode for controlling the motor from the first control mode to the second control mode in a state where the rotor is being rotated at a predetermined speed based on the first control mode.

### BACKGROUND OF THE INVENTION

### Field of the Invention

The present invention relates to motor control in a motor control apparatus, a sheet conveyance apparatus, a document feeding apparatus, a document reading apparatus, and an image forming apparatus.

### Description of the Related Art

In a known conventional configuration, a stepping motor (hereinafter referred to as a motor) is driven in response to switching between phases of windings magnetized according to drive pulses output from a higher level apparatus, such as a central processing unit (CPU). The number of drive pulses corresponds to the phase lead amount of the rotor of the motor, and the interval (frequency) of drive pulses corresponds to an instructed speed representing a target speed for the rotor.

Conventionally, a control method called vector control is known as a method for controlling a motor. In vector control, current values are controlled in a rotating coordinate system based on the rotation phase of the rotor of the motor. More specifically, there is a known control method that controls the motor by performing phase feedback control in which current values are controlled in the rotating coordinate system so as to reduce the deviation between an instructed phase for the rotor and the rotation phase of the rotor. There is another known control method that controls a motor by performing speed feedback control in which current values are controlled in the rotating coordinate system so as to reduce the deviation between an instructed speed for the rotor and the rotation speed of the rotor.

In vector control, drive currents flowing in the windings of the motor are represented by the q-axis component (torque current component) as a current component for generating torque for rotating the rotor and the d-axis component (exciting current component) as a current component affecting the intensity of the magnetic flux penetrating the windings of the motor. Torque required to rotate the rotor is efficiently generated by controlling the value of the torque current component according to change in the load torque applied to the rotor. As a result, the increase in motor sound and the increase in power consumption due to residual torque are restrained. If the load torque applied to the rotor exceeds the output torque corresponding to the drive currents supplied to the windings of the motor, the rotor becomes out of synchronization with the input signal, and the motor becomes out of control (step-out state). Vector control can prevent the motor from entering a step-out state.

In vector control, a configuration for determining the rotation phase of the rotor is required. U.S. Pat. No. 8,970,146 discusses a configuration for determining the rotation phase of the rotor based on the inductive voltage generated in the winding of each phase of a motor by the rotation of the rotor.

The magnitude of the induced voltage generated in the windings decreases with decreasing rotation speed of the rotor. If the magnitude of the inductive voltage generated in the windings is not sufficient to determine the rotation phase of the rotor, the rotation phase may not be determined with sufficient accuracy. This means that the accuracy for determining the rotation phase of the rotor may possibly degrade with decreasing rotation speed of the rotor.

Japanese Patent Application Laid-Open No. 2005-39955 discusses a configuration in which a constant current control for controlling a motor by supplying predetermined currents to windings of the motor is used when an instructed speed for the rotor is lower than a predetermined rotation speed of the rotor. In constant current control, neither phase feedback control nor speed feedback control is performed. Japanese Patent Application Laid-Open No. 2005-39955 further discusses a configuration in which a vector control is used when the instructed speed for the rotor is equal to or higher than the predetermined rotation speed of the rotor.

FIG. 11 is a diagram illustrating an example relation between an instructed speed ω_ref indicating a target speed for the rotor of the motor and an actual rotation speed ω of the rotor of the motor. Referring to FIG. 11, the one-point chain line denotes the instructed speed ω_ref, and the solid line denotes the rotation speed ω. The one-point chain line overlaps with the solid line in a time period from when the motor drive is started to when the motor deceleration is started and in a time period from when the instructed speed ω_ref decreases to a threshold value ωth or less to when the motor drive is stopped. The waveform of the instructed speed ω_ref and the number of drive pulses to be output from a host apparatus from when the motor drive is started to when the motor drive is stopped are preset, for example, based on a drive sequence of the motor. More specifically, a preset number of drive pulses are output from the host apparatus in a time period from when the motor control method is switched from vector control to constant current control to when the motor is stopped.

As illustrated in FIG. 11, when the instructed speed ω_ref starts decreasing, the rotation speed ω does not immediately follow the instructed speed ω_ref, and the value of the rotation speed ω, thus, becomes higher than that of the instructed speed ω_ref. More specifically, the rotation phase of the rotor leads the target phase for the rotor because the rotor rotating at a constant speed will maintain the rotation at the constant speed due to inertia.

For example, when the instructed speed ω_ref decreases during execution of vector control the rotation phase of the rotor can lead the target phase, a motor control apparatus is able to control a drive current provided to the motor so that a difference between the rotation phase and the target phase is reduced so that the rotation phase and the target phase coincide with one another. This may possibly cause a state where the rotation phase leads the target phase by an electrical angle of 360 degrees or more due to a control delay.

In the configuration in which a predetermined number of drive pulses are output from the host apparatus in a time period from when the motor control method is switched from vector control to constant current control to when the motor is stopped, the following issue may arise when the motor control method is switched from vector control to constant current control. More specifically, when the motor control method is switched from vector control to constant current control in a state where the rotation phase leads the target phase by an electrical angle of 360 degrees or more, the rotation phase at which the rotor is stopped may possibly lead the phase at which the rotor needs to be stopped, or the rotation phase is stopped at a phase or position that is in front of a desired stopping phase or position.

For example, in a case where a stepping motor is used to drive a conveyance roller disposed in a sheet conveyance apparatus for conveying a sheet, if the rotation phase at which the rotor is stopped leads the phase at which the rotor needs to be stopped, the amount of sheet conveyance may not be controlled correctly.

The present invention is directed to performing the motor control with high accuracy.

### SUMMARY OF THE INVENTION

According to an aspect of the present invention, a motor control apparatus for controlling a motor based on an instructed phase indicating a target phase of a rotor of the motor includes a detector configured to detect a drive current flowing in a winding of the motor, a phase determiner configured to determine a rotation phase of the rotor based on the drive current detected by the detectors, and a controller provided with a first control mode for controlling the motor by controlling the drive current flowing in the winding of the motor so as to reduce a deviation between the instructed phase and the rotation phase determined by the phase determiner, and a second control mode for controlling the motor based on a current having a predetermined magnitude. The controller decelerates the rotor after switching a control mode for controlling the motor from the first control mode to the second control mode in a state where the rotor is being rotated at a predetermined speed based on the first control mode.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming apparatus.

FIG. 2 is a block diagram illustrating a control configuration of the image forming apparatus.

FIG. 3 is a diagram illustrating a relation between a two-phase motor including phases A and B and a rotating coordinate system represented by d and q axes.

FIG. 4 is a block diagram illustrating a configuration of a motor control apparatus according to a first embodiment.

FIG. 5 is a block diagram illustrating a configuration of an instruction generator.

FIG. 6 illustrates an example of a method for implementing a micro step drive system.

FIG. 7 is a diagram illustrating a configuration for correcting skew of the side of the leading edge of a recording medium.

FIG. 8 illustrates switching between motor control methods.

FIG. 9 is a flowchart illustrating motor control processing performed by the motor control apparatus.

FIG. 10 illustrates an example of a motor drive sequence.

FIG. 11 illustrates a relation between an instructed speed ω_ref and an actual rotation speed ω in conventional motor control.

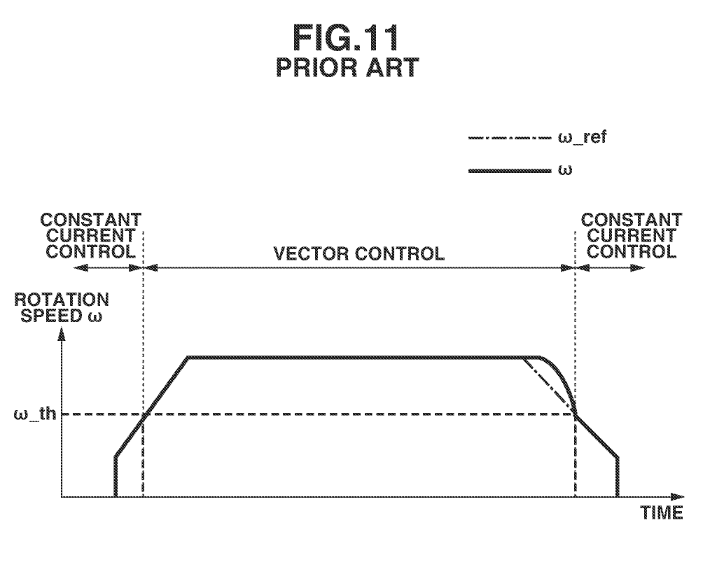

### DESCRIPTION OF THE EMBODIMENTS

embodiments of the present invention will be described below with reference to the accompanying drawings. However, shapes and relative arrangements of elements described in the embodiments are not limited thereto and are to be modified as required depending on the configuration of an apparatus according to the present invention and other various conditions. The scope of the present invention is not limited to the embodiments described below. Although, in a case described below, an image forming apparatus is provided with a motor control apparatus, apparatuses provided with a motor control apparatus are not limited to image forming apparatuses. For example, a motor control apparatus is also used for a sheet conveyance apparatus for conveying sheets such as recording media and documents.

### [Image Forming Apparatus]

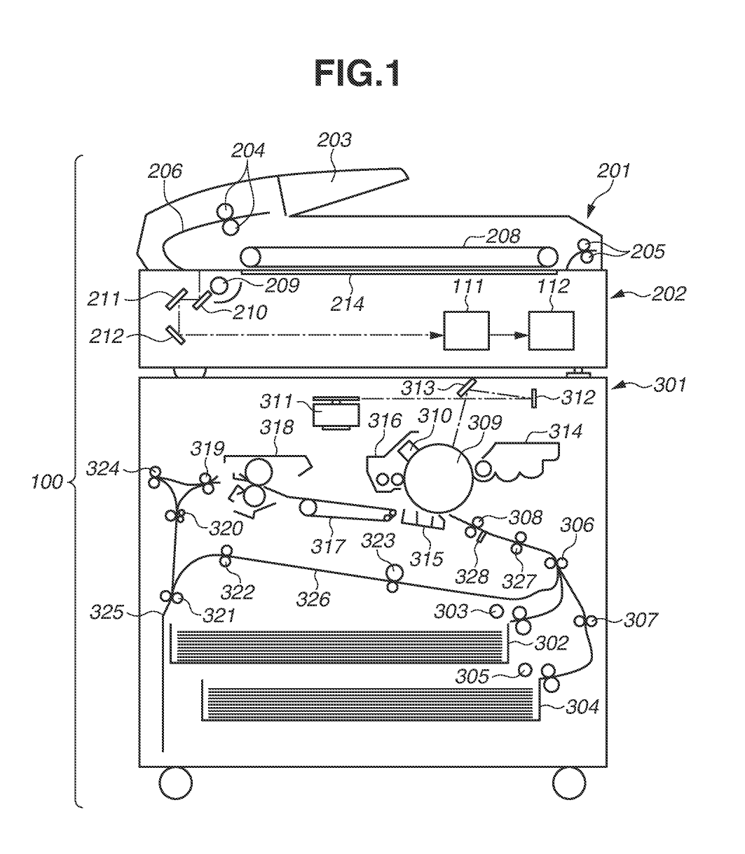

A first embodiment will be described below. FIG. 1 is a cross-sectional view illustrating a configuration of a monochrome electrophotographic copying machine (image forming apparatus) 100 including the sheet conveyance apparatus according to the present embodiment. The image forming apparatus is not limited to a copying machine and may be a facsimile, a printing machine, or a printer, for example. The recording system is not limited to the electrophotographic system and may be the ink-jet system. The image forming apparatus may be of either monochrome or color type.

A configuration and functions of an image forming apparatus 100 will be described below with reference to FIG. 1. As illustrated in FIG. 1, the image forming apparatus 100 includes a document feeding apparatus 201, a reading apparatus 202, and an image printing apparatus 301.

A document stacked on a document stacking unit 203 of the document feeding apparatus 201 is fed by feed rollers 204. Then, the document is conveyed along a conveyance guide 206 up to a document positioning glass plate 214 of the reading apparatus 202. The document is further conveyed by a conveyance belt 208 and discharged onto a discharge tray (not illustrated) by discharge rollers 205. Reflected light from a document image illuminated by an illumination system 209 at the reading position of the reading apparatus 202 is led to an image reading unit 111 by an optical system (including reflection mirrors 210, 211, and 212). Then, the reflected light is converted into an image signal by the image reading unit 111. The image reading unit 111 includes lenses, a charge coupled device (CCD) sensor as a photoelectric conversion element, and a CCD drive circuit. An image signal output from the image reading unit 111 undergoes various correction processing by an image processing unit 112 including hardware devices, such as an application specific integrated circuit (ASIC). Then, the image signal is output to the image printing apparatus 301. A document is read in this way. That is, the document feeding apparatus 201 and the reading apparatus 202 function as a document reading apparatus.

There are two different document reading modes: the first reading mode and the second reading mode. The first reading mode is a mode for reading an image of a document conveyed at a constant speed by using the illumination system 209 and an optical system fixed at predetermined positions. The second reading mode is a mode for reading an image of a document placed on the document positioning glass plate 214 of the reading apparatus 202 by using the illumination system 209 and the optical system moving at a constant speed. Normally, an image of a sheet of document is read in the first reading mode, and images of a bound document, such as a book and a booklet, is read in the second reading mode.

The image printing apparatus 301 includes sheet storage trays 302 and 304. Different types of recording media can be stored in the sheet storage trays 302 and 304. For example, plain paper of the A4 size is stored in the sheet storage tray 302, and thick paper of the A4 size is stored in the sheet storage tray 304. Examples of recording media include paper, resin sheets, cloths, overhead projection (OHP) sheets, labels, and other media on which an image is formed by an image forming apparatus.

Recording media stored in the sheet storage tray 302 are fed by a pickup roller 303 and then sent out to a registration roller 308 by a conveyance roller 306 and a pre-registration roller 327. Recording media stored in the sheet storage tray 304 are fed by a pickup roller 305 and then sent out to the registration roller 308 by the conveyance rollers 307 and 306 and the pre-registration roller 327.

An image signal output from the reading apparatus 202 is input to a light scanning apparatus 311 including a semiconductor laser unit and a polygon mirror. The outer circumferential surface of a photosensitive drum 309 is charged by a charging unit 310. After the outer circumferential surface of the photosensitive drum 309 is charged, laser light according to the image signal input from the reading apparatus 202 to the light scanning apparatus 311 passes through the light scanning apparatus 311, the polygon mirror, and mirrors 312 and 313, and is irradiated onto the outer circumferential surface of the photosensitive drum 309. As a result, an electrostatic latent image is formed on the outer circumferential surface of the photosensitive drum 309.

Subsequently, the electrostatic latent image is developed with toner in a developing unit 314, and a toner image is formed on the outer circumferential surface of the photosensitive drum 309.

A sheet sensor 328 as a sheet detection unit for detecting the leading edge of a recording medium is disposed between the registration roller 308 and the pre-registration roller 327. The registration roller 308 and the pre-registration roller 327 correct skew of the side of the leading edge of the recording medium based on the detection result of the sheet sensor 328. A specific method for correcting skew will be described below.

The toner image formed on the photosensitive drum 309 is transferred onto the recording medium by the transfer charging unit 315 disposed at a position (transfer position) facing the photosensitive drum 309. In synchronization with this transfer timing, the registration roller 308 and the pre-registration roller 327 send the recording medium to the transfer position. Although the sheet sensor 328 according to the present embodiment is, for example, an optical sensor, the sheet sensor 328 is not limited thereto.

As described above, the recording medium with a toner image transferred thereon is sent to a fixing unit 318 by a conveyance belt 317 and then heated and pressurized by the fixing unit 318. Then, the toner image is fixed onto the recording medium. In this way, an image is formed on the recording medium by the image forming apparatus 100.

In the case of image formation in the one-side printing mode, the recording medium that has passed the fixing unit 318 is discharged onto the discharge tray (not illustrated) by discharge rollers 319 and 324. In the case of image formation in the double-side printing mode, fixing processing is performed on the first surface of the recording medium by the fixing unit 318, and the recording medium is conveyed to a reversing path 325 by the discharge roller 319, a conveyance roller 320, and a reversing roller 321. Then, the recording medium is conveyed again to the registration roller 308 by conveyance rollers 322 and 323. An image is formed on the second surface of the recording medium through the above-described method. Then, the recording medium is discharged onto the discharge tray (not illustrated) by the discharge rollers 319 and 324.

When the recording medium with an image formed on the first surface is to be discharged out of the image forming apparatus 100 with the first surface down, the recording medium that has passed the fixing unit 318 passes through the discharge roller 319 and is conveyed in the direction toward the conveyance roller 320. Then, the rotation of the conveyance roller 320 is reversed immediately before the trailing edge of the recording medium passes through the nip portion between the conveyance roller 320 and an opposing roller. Then, the recording medium passes through the discharge roller 324 with the first surface down and then is discharged out of the image forming apparatus 100.

The description of the configuration and functions of the image forming apparatus 100 has been given. A load according to the present embodiment refers to an object driven by a motor. For example, various rollers (conveyance rollers) including the feed rollers 204, 303, and 305, the registration roller 308, and the discharge roller 319 correspond to loads according to the present embodiment. The motor control apparatus according to the present embodiment is applicable to motors for driving these loads.

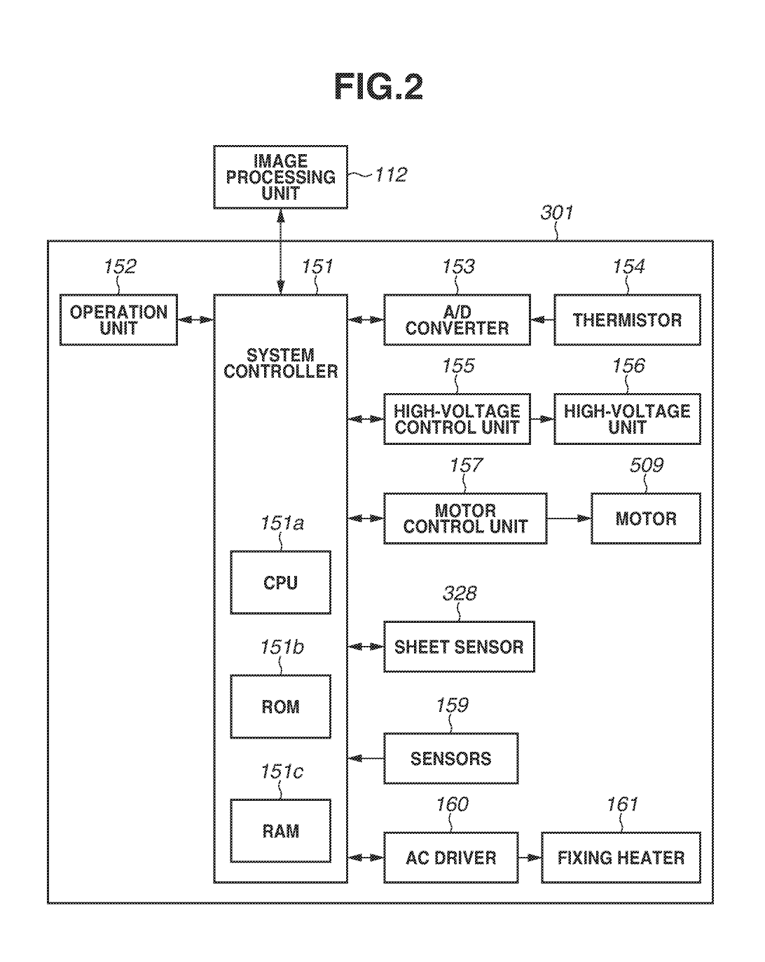

FIG. 2 is a block diagram illustrating an example of a control configuration of the image forming apparatus 100. A system controller 151 includes a CPU 151a, a read only memory (ROM) 151b, and a random access memory (RAM) 151c as illustrated in FIG. 2. The system controller 151 is connected with the image processing unit 112, an operation unit 152, an analog-to-digital (A/D) converter 153, a high-voltage control unit 155, a motor control apparatus 157, sensors 159, and an alternating current (AC) driver 160. The system controller 151 can transmit and receive data and commands to/from each unit connected thereto.

The CPU 151a reads various programs stored in the ROM 151b and executes the read programs to perform various sequences related to a predetermined image forming sequence.

The RAM 151c is a memory device for storing various data including setting values for the high-voltage control unit 155, command values for the motor control apparatus 157, and information received from the operation unit 152.

The system controller 151 transmits, to the image processing unit 112, setting value data of various apparatuses disposed in the image forming apparatus 100, which are required for image processing in the image processing unit 112. The system controller 151 also receives signals from the sensors 159 and sets setting values of the high-voltage control unit 155 based on the received signals.

The high-voltage control unit 155 supplies the voltage required for the high voltage unit 156 (including the charging unit 310, the developing unit 314, and the transfer charging unit 315) according to the setting values set by the system controller 151.

The CPU 151a outputs an instruction to the motor control apparatus 157 based on the detection result of the sheet sensor 328. According to the command output from the CPU 151a, the motor control apparatus 157 controls a motor 509 for driving the pre-registration roller 327. Although, in FIG. 2, only the motor 509 is illustrated as a motor of the image forming apparatus 100, a plurality of motors is actually disposed in the image forming apparatus 100. In addition, one motor control apparatus may be configured to control a plurality of motors. Although, in FIG. 2, one motor control apparatus is disposed, a plurality of motor control apparatuses is actually disposed in the image forming apparatus 100.

The A/D converter 153 receives a detection signal detected by a thermistor 154 for detecting the temperature of a fixing heater 161, converts the detected signal as an analog signal into a digital signal, and transmits the digital signal to the system controller 151. The system controller 151 controls the AC driver 160 based on the digital signal received from the A/D converter 153. The AC driver 160 controls the fixing heater 161 to set the temperature of the fixing heater 161 to the temperature required to perform fixing processing. The fixing heater 161 included in the fixing unit 318 is used for fixing processing.

The system controller 151 controls the operation unit 152 to display an operation screen for enabling a user to set the type of the recording medium to be used (hereinafter referred to as a paper type) on the display unit provided on the operation unit 152. The system controller 151 receives user-set information from the operation unit 152 and controls an operation sequence of the image forming apparatus 100 based on the user-set information. The system controller 151 also transmits information indicating the status of the image forming apparatus 100 to the operation unit 152. Examples of the information indicating the status of the image forming apparatus 100 include the number of sheets on which an image is formed, the progress status of image forming operations, and information about jam and double feed of sheet materials in the document feeding apparatus 201 and the image printing apparatus 301. The operation unit 152 displays the information received from the system controller 151 on the display unit.

As described above, the system controller 151 controls the operation sequence of the image forming apparatus 100.

### [Motor Control Apparatus]

The motor control apparatus 157 according to the present embodiment will be described below. The motor control apparatus 157 according to the present embodiment can perform motor control by using either of the two control methods: vector control as a first control mode and constant current control as a second control mode. In the following descriptions, control is performed based on a rotation phase θ and an instructed phase θ_ref, and the current phase as electrical angles. However, for example, the electrical angles may be converted into mechanical angles, and the following control may be performed based on the mechanical angles.

### <Vector Control>

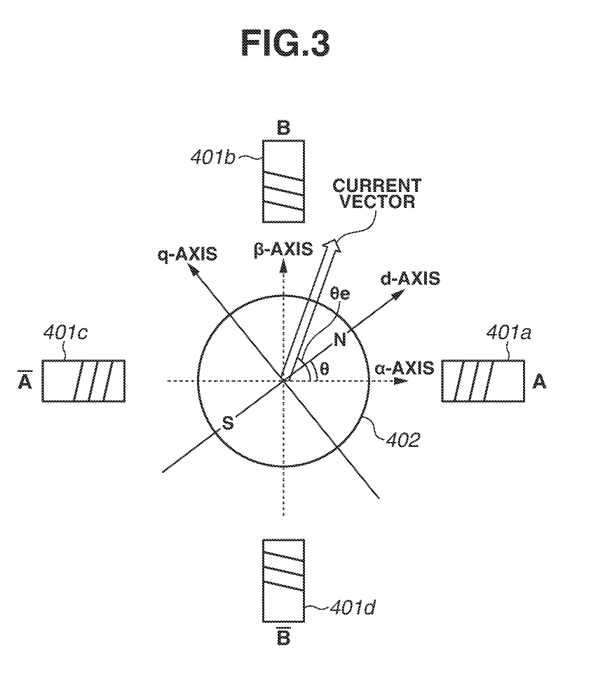

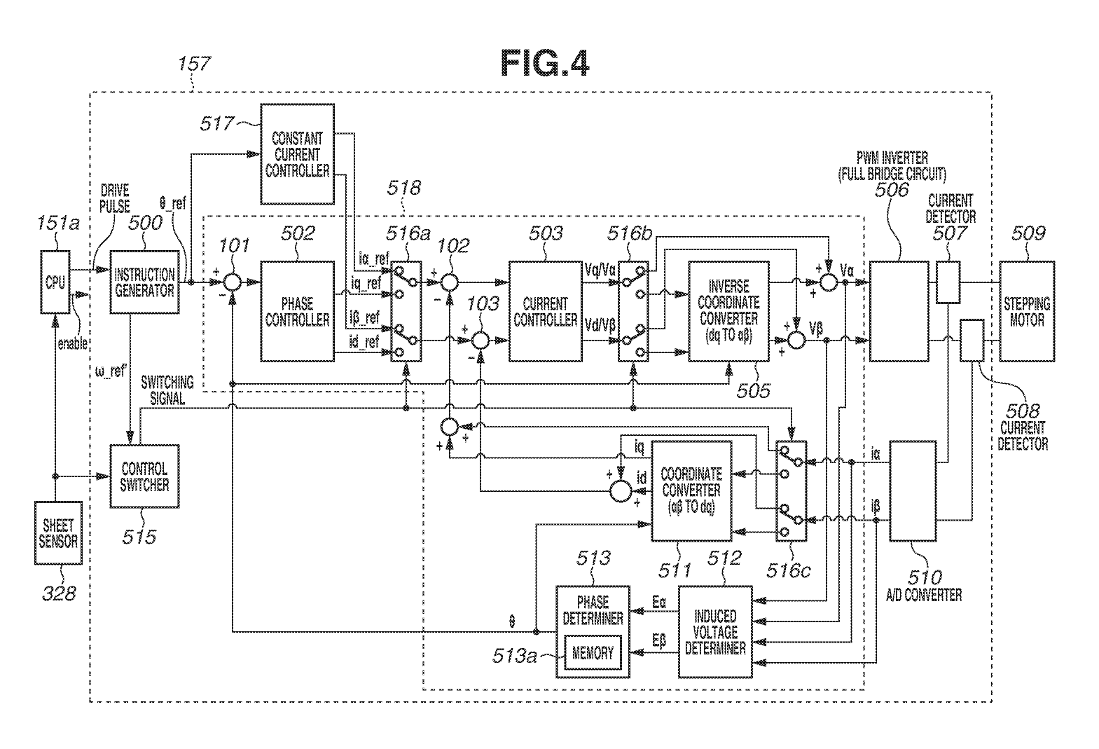

The vector control method performed by the motor control apparatus 157 according to the present embodiment will be described below with reference to FIGS. 3 and 4. The motor described below is not provided with sensors such as a rotary encoder for detecting the rotation phase of the rotor of the motor.

FIG. 3 illustrates a relation between a stepping motor (hereinafter referred to as a motor) 509 including two phases, phase A (first phase) and phase B (second phase), and a rotating coordinate system represented by the d and q axes. Referring to FIG. 3, in a stationary coordinate system, the α axis is defined as an axis corresponding to the winding of phase A, and the β axis is defined as an axis corresponding to the winding of phase B. Referring to FIG. 3, the d axis is defined along the direction of the magnetic flux generated by the magnetic pole of a permanent magnet used for a rotor 402, and the q axis is defined along the direction which leads the d axis by 90 degrees in the counterclockwise direction (along a direction perpendicularly intersecting with the d axis). The angle formed by the α and the d axes is defined as θ, and the rotation phase of the rotor 402 is represented by the angle θ. In vector control, a rotating coordinate system based on the rotation phase θ of the rotor 402 is used. More specifically, in vector control, two different current components of a current vector (in the rotating coordinate system) corresponding to the drive currents flowing in the windings are used. One current component is the q-axis component (torque current component) which generates torque in the rotor, and the other current component is the d-axis component (exciting current component) which affects the intensity of the magnetic flux penetrating the windings.

Vector control refers to a control method for controlling the motor by performing phase feedback control to control the value of the torque current component and the value of the exciting current component so as to reduce the deviation between the instructed phase indicating the target phase for the rotor and the actual rotation phase of the rotor. There is another control method for controlling the motor by performing speed feedback control to control the value of the torque current component and the value of the exciting current component so as to reduce the deviation between the instructed speed indicating the target speed of the rotor and the actual rotation speed of the rotor.

FIG. 4 is a block diagram illustrating an example of a configuration of the motor control apparatus 157 for controlling the motor 509. The motor control apparatus 157 includes at least one ASIC and performs the following functions.

As illustrated in FIG. 4, the motor control apparatus 157 includes a constant-current controller 517 for performing constant current control, and a vector controller 518 for performing vector control.

The motor control apparatus 157 includes, as circuits for performing vector control, a phase controller 502, a current controller 503, an inverse coordinate converter 505, a coordinate converter 511, and a pulse width modulation (PWM) inverter 506 for supplying drive currents to the windings of the motor. The coordinate converter 511 converts the coordinate system of the current vector corresponding to the drive currents flowing in the windings of phases A and B of the motor 509 from the stationary coordinate system denoted by the α and the β axes into the rotating coordinate system denoted by the q and the d axes. As a result, the drive currents flowing in the windings are represented by the current value of the q-axis component (q-axis current) and the current value of the d-axis component (d-axis current) as current values in the rotating coordinate system. The q-axis current is equivalent to a torque current for generating torque in the rotor 402 of the motor 509. The d-axis current is equivalent to an exciting current affecting the intensity of the magnetic flux penetrating the windings of the motor 509. The motor control apparatus 157 can independently control the q-axis and the d-axis currents. As a result, by controlling the q-axis current according to the load torque applied to the rotor 402, the motor control apparatus 157 can efficiently generate torque required to rotate the rotor 402. In other words, in vector control, the magnitude of the current vector illustrated in FIG. 3 changes with the load torque applied to the rotor 402.

The motor control apparatus 157 determines the rotation phase θ of the rotor 402 of the motor 509 based on the method to be described below and performs vector control based on the determination result. Based on the operation sequence of the motor 509, the CPU 151a outputs drive pulses as an instruction for driving the motor 509 to an instruction generator 500. The operation sequence (motor drive pattern) of the motor 509 is stored, for example, in the ROM 151b. The CPU 151a outputs drive pulses as a pulse train based on the operation sequence stored in the ROM 151b.

The instruction generator 500 generates and outputs the instructed phase θ_ref indicating the target phase for the rotor 402 based on the drive pulses output from the CPU 151a. The configuration of the instruction generator 500 will be described below.

A subtractor 101 calculates and outputs the deviation between the rotation phase θ and the instructed phase θ_ref of the rotor 402 of the motor 509.

The phase controller 502 acquires a deviation Δθ at intervals T (for example, at intervals of 200 ρs). The phase controller 502 generates and outputs a q-axis current instructed value iq_ref and a d-axis current instructed value id_ref so as to reduce the deviation output from the subtractor 101, based on proportional control (P), integral control (I), and differential control (D). More specifically, the phase controller 502 generates and outputs the q-axis current instructed value iq_ref and the d-axis current instructed value id_ref so that the deviation output from the subtractor 101 becomes 0, based on P, I, and D control. P control refers to a control method for controlling a control target value based on a value proportional to the deviation between an instructed value and an estimated value. I control refers to a control method for controlling a control target value based on a value proportional to the time integration of the deviation between an instructed value and an estimated value. D control refers to a control method for controlling a control target value based on a value proportional to the time variation of the deviation between an instructed value and an estimated value. Although the phase controller 502 according to the present embodiment generates the q-axis current instructed value iq_ref and the d-axis current instructed value id_ref based on PID control, the present invention is not limited thereto. For example, the phase controller 502 may generate the q-axis current instructed value iq_ref and the d-axis current instructed value id_ref based on PI control. Although, in a case where a permanent magnet is used for the rotor 402, the d-axis current instructed value id_ref affecting the intensity of the magnetic flux penetrating the windings is regularly set to 0, the present invention is not limited thereto.

The drive current flowing in the winding of phase A of the motor 509 is detected by a current detector 507. Then, the detected drive current as an analog value is converted into a digital value by an A/D converter 510. The drive current flowing in the winding of phase B of the motor 509 is detected by a current detector 508. Then, the drive current as an analog value is converted into a digital value by the A/D converter 510. The interval (predetermined interval) at which the current detectors 507 and 508 detect currents is, for example, an interval T or less (for example, 25 μs) at which the phase controller 502 acquires the deviation Δθ.

The current value of the drive current as an analog value converted into a digital value by the A/D converter 510 is represented by the following formulas (1) and (2), where iα and iβ denote current values in the stationary coordinate system and θe denotes the phase of the current vector illustrated in FIG. 3. The phase θe of the current vector is defined as the angle formed by the α axis and the current vector. I denotes the magnitude of the current vector.

iα=I*cos θe (1)

iβ=I*sin θe (2)

The current values iα and iβ are input to the coordinate converter 511 and an induced voltage determiner 512.

The coordinate converter 511 converts the current values iα and iβ in the stationary coordinate system into a current value iq of the q-axis current and a current value id of the d-axis current in the rotating coordinate system, by using the following formulas (3) and (4):

id=cos θ*iα+sin θ*iβ (3), and

iq=−sin θ*iα+cos θ*iβ (4).

The q-axis current instructed value iq_ref output from the phase controller 502 and the current value iq output from the coordinate converter 511 are input to a subtractor 102. The subtractor 102 calculates the deviation between the q-axis current instructed value iq_ref and the current value iq and outputs the deviation to the current controller 503.

The d-axis current instructed value id_ref output from the phase controller 502 and the current value id output from the coordinate converter 511 are input to a subtractor 103. The subtractor 103 calculates the deviation between the d-axis current instructed value id_ref and the current value id and outputs the deviation to the current controller 503.

Based on PID control, the current controller 503 generates a drive voltage Vq so as to reduce the deviation output from the subtractor 102. More specifically, the current controller 503 generates the drive voltage Vq so that the deviation output from the subtractor 102 becomes 0, and outputs the drive voltage Vq to the inverse coordinate converter 505.

The current controller 503 generates a drive voltage Vd so as to reduce the deviation output from the subtractor 103 based on PID control. More specifically, the current controller 503 generates the drive voltage Vd so that the deviation output from the subtractor 103 becomes 0, and outputs the drive voltage Vd to the inverse coordinate converter 505.

Although the current controller 503 according to the present embodiment generates the drive voltages Vq and Vd based on PID control, the present invention is not limited thereto. For example, the current controller 503 may generate the drive voltages Vq and Vd based on PI control.

The inverse coordinate converter 505 inversely converts the drive voltages Vq and Vd in the rotating coordinate system output from the current controller 503 into drive voltages Vα and Vβ in the stationary coordinate system, by using the following formulas (5) and (6):

Vα=cos θ*Vd−sin θ*Vq (5), and

Vβ=sin θ*Vd+cos θ*Vq (6).

The inverse coordinate converter 505 outputs the inversely converted drive voltages Vα and Vβ to the induced voltage determiner 512 and the PWM inverter 506.

The PWM inverter 506 includes a full bridge circuit which is driven by a PWM signal based on the drive voltages Vα and Vβ input from the inverse coordinate converter 505. As a result, the PWM inverter 506 generates the drive currents iα and iβ according to the drive voltages Vα and Vβ, respectively, and supplies the drive currents iα and iβ to the windings of respective phases of the motor 509 to drive the motor 509. In other words, the PWM inverter 506 functions as a supply unit for supplying currents to the windings of respective phases of the motor 509. Although, in the present embodiment, the PWM inverter 506 includes a full bridge circuit, the PWM inverter may be, for example, a half bridge circuit.

A configuration for determining the rotation phase θ will be described below. The values of induced voltages Eα and Eβ induced in the windings of phases A and B of the motor 509, respectively, by the rotation of the rotor 402 are used to determine the rotation phase θ of the rotor 402. The values of the induced voltages are determined (calculated) by the induced voltage determiner 512. More specifically, the induced voltages Eα and Eβ are determined based on the current values iα and iβ input from the A/D converter 510 to the induced voltage determiner 512, and the drive voltages Vα and Vβ input from the inverse coordinate converter 505 to the induced voltage determiner 512, by using the following formulas (7) and (8):

Eα=Vα−R*iα−L*diα/dt (7), and

Eβ=Vβ−R*iβ−L*diβ/dt (8).

In the formulas, R denotes the winding resistance, and L denotes the winding inductance. The values of the winding resistance R and the winding inductance L are values specific to the motor 509 used, and are prestored in a memory (not illustrated) provided in the ROM 151b or the motor control apparatus 157, for example.

The induced voltages Eα and Eβ determined by the induced voltage determiner 512 are output to a phase determiner 513.

The phase determiner 513 determines the rotation phase θ of the rotor 402 of the motor 509 based on the ratio of the induced voltages Eα and Eβ output from the induced voltage determiner 512, by using the following formula (9):

θ=tan \hat{ }−1(−Eβ/Eα) (9).

Although, in the present embodiment, the phase determiner 513 determines the rotation phase θ by performing the calculation based on the formula (9), the present invention is not limited thereto. For example, the phase determiner 513 may determine the rotation phase θ by referencing a table indicating the relation between the induced voltages Eα and Eβ and the rotation phase θ corresponding to the induced voltages Eα and Eβ stored in a memory 513a.

The rotation phase θ of the rotor 402 obtained as described above is input to the subtractor 101, the inverse coordinate converter 505, and the coordinate converter 511.

When performing vector control, the motor control apparatus 157 repetitively performs the above-described control.

As described above, the motor control apparatus 157 according to the present embodiment performs vector control through phase feedback control for controlling the current values in the rotating coordinate system so as to reduce the deviation between the instructed phase θ_ref and the rotation phase θ. Performing vector control enables prevention of a step-out condition of the motor and prevention of the increase in motor sound and the increase in power consumption due to residual torque.

### <Constant Current Control>

Constant current control according to the present embodiment will be described below.

In constant current control, the drive currents flowing in the windings are controlled when predetermined currents are supplied to the windings of a motor. More specifically, in constant current control, to prevent the motor from entering a step-out condition even if the load torque applied to the rotor fluctuates, the windings are supplied with drive currents having a magnitude (amplitude) corresponding to the sum of torque assumed to be required to rotate the rotor and a predetermined margin for the following reason. In constant current control, the drive current cannot be adjusted according to the load torque applied to the rotor because the configuration for controlling the magnitude of the drive current based on the determined (presumed) rotation phase and rotation speed is not used (i.e., feedback control is not performed). The larger the magnitude of the current, the larger the torque to be applied to the rotor. The amplitude of the current corresponds to the magnitude of the current vector.

Although, in the following descriptions, a motor is controlled when the windings are supplied with currents having a predetermined magnitude during constant current control, the present invention is not limited thereto. For example, during constant current control, a motor may be controlled when the windings are supplied with currents having a magnitude predetermined for each of acceleration and deceleration of the motor.

Referring to FIG. 4, the instruction generator 500 outputs the instructed phase θ_ref to the constant-current controller 517 based on the drive pulses output from the CPU 151a. The constant-current controller 517 generates and outputs current instructed values iα_ref and iβ_ref in the stationary coordinate system corresponding to the instructed phase θ_ref output from the instruction generator 500. According to the present embodiment, the magnitude of the current vector corresponding to the current instructed values iα_ref and iβ_ref in the stationary coordinate system is always constant.

The drive currents flowing in the windings of phases A and B of the motor 509 are detected by the current detectors 507 and 508, respectively. The drive currents detected as analog values are converted into digital values by the A/D converter 510, as described above.

The current value is output from the A/D converter 510 and the current instructed value iα_ref output from the constant-current controller 517 are input to the subtractor 102. The subtractor 102 calculates the deviation between the current instructed value iα_ref and the current value iα and outputs the deviation to the current controller 503.

In addition, the current value iβ output from the A/D converter 510 and the current instructed value iβ_ref output from the constant-current controller 517 are input to the subtractor 103. The subtractor 103 calculates the deviation between the current instructed value iβ_ref and the current value iβ and outputs the deviation to the current controller 503.

The current controller 503 outputs the drive voltages Vα and Vβ based on PID control so as to reduce the input deviation. More specifically, the current controller 503 outputs the drive voltages Vα and Vβ so that the input deviation approaches 0.

By using the above-described method, the PWM inverter 506 supplies drive currents to the windings of respective phases of the motor 509 based on the input drive voltages Vα and Vβ to drive the motor 509.

As described above, in the constant current control according to the present embodiment, neither phase feedback control nor speed feedback control is performed. In other words, in the constant current control according to the present embodiment, the drive currents supplied to the windings are not adjusted according to the rotation condition of the rotor. Thus, in the constant current control, the windings are supplied with currents as the sum of the current required to rotate the rotor and a predetermined margin to prevent the motor from entering a step-out condition.

### <Instruction Generator>

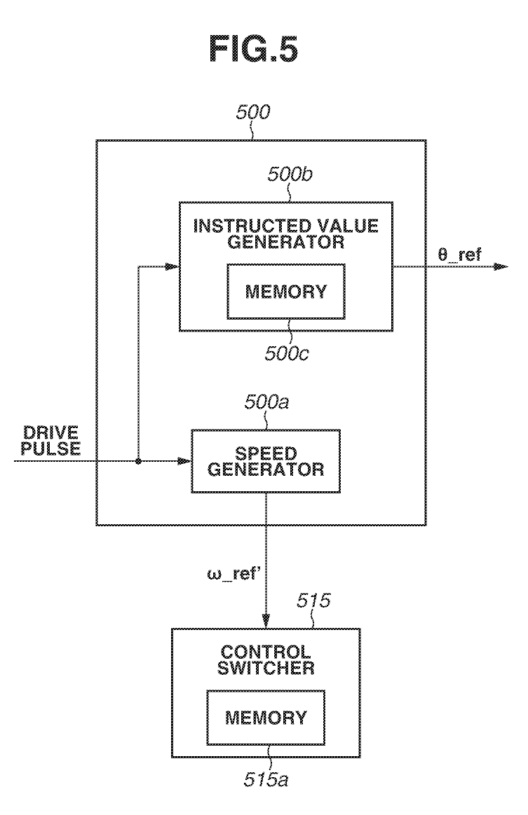

FIG. 5 is a block diagram illustrating a configuration of the instruction generator 500 according to the present embodiment. As illustrated in FIG. 5, the instruction generator 500 includes a speed generator 500a as a speed determination unit for generating a rotation speed ω_ref′ instead of the instructed speed, and an instructed value generator 500b for generating an instructed phase θ_ref based on the drive pulses output from the CPU 151a.

The speed generator 500a generates and outputs the rotation speed ω_ref based on the time interval between falling edges of the continuous drive pulses. In other words, the rotation speed ω_ref′ changes at intervals corresponding to the interval of the drive pulses.

The instructed value generator 500b generates and outputs the instructed phase θ_ref based on the drive pulses output from the CPU 151a, by using the following formula (10):

θ_ref=θini+θstep*n (10).

θini denotes the phase (initial phase) of the rotor when the motor drive is started. θstep denotes the amount of increase (variation) of the instructed phase θ_ref for each drive pulse, and n denotes the number of pulses input to the instructed value generator 500b.

### {Micro Step Drive System}

According to the present embodiment, a micro step drive system is used in constant current control. The drive system used in constant current control may not necessarily be limited to the micro step drive system and may be, for example, a full step drive system.

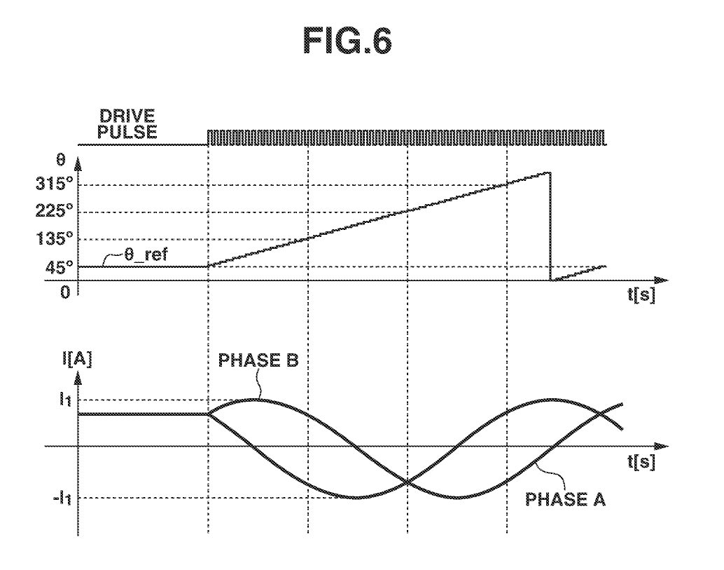

FIG. 6 illustrates an example method for implementing the micro step drive system. FIG. 6 illustrates the drive pulses output from the CPU 151a, the instructed phase θ_ref generated by the instructed value generator 500b, and the currents flowing in the windings of phases A and B.

A method for performing the micro step drive according to the present embodiment will be described below with reference to FIGS. 5 and 6. The drive pulses and the instructed phase θ_ref illustrated in FIG. 6 indicate a state where the rotor is rotating at a constant speed.

In the micro step drive system, the lead amount of the instructed phase θ_ref equals the amount obtained by dividing 90 degrees, which is the lead amount of the instructed phase θ_ref in the full step drive system, by N (N is a positive integer), i.e., 90/N degrees. As a result, the current waveform smoothly changes in the shape of a sine wave, as illustrated in FIG. 6, making it possible to more finely control the rotation phase θ of the rotor.

In a case where the micro step drive is performed, the instructed value generator 500b generates and outputs the instructed phase θ_ref based on the drive pulses output from the CPU 151a, by using the following formula (11):

θ_ref=45°+90/N°*n (11).

When one drive pulse is input, the instructed value generator 500b adds 90/N degrees to the instructed phase θ_ref to update the instructed phase θ_ref. In other words, the number of drive pulses output from the CPU 151a corresponds to the instructed phase θ_ref. The interval (frequency) of the drive pulses output from the CPU 151a corresponds to the target speed (instructed speed) of the motor 509.

### <Drive of Pre-Registration Roller>

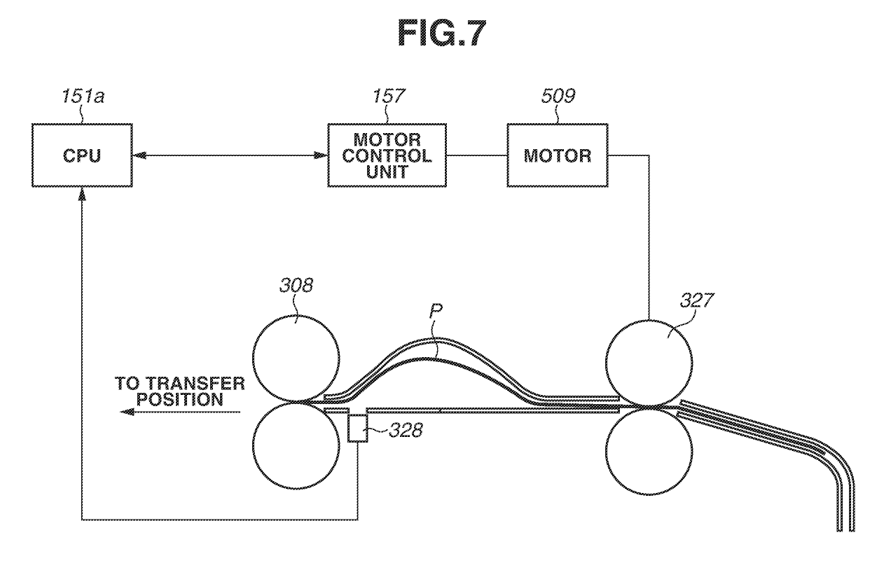

FIG. 7 is a diagram illustrating a configuration for correcting skew of the side of the leading edge of the recording medium P.

Skew correction for the recording medium P is performed by the registration roller 308 and the pre-registration roller 327. More specifically, when the motor control apparatus 157 controls the drive of the motor 509, the motor 509 rotates, and accordingly the pre-registration roller 327 rotates. When the pre-registration roller 327 rotates to convey the recording medium P in the conveyance direction, the leading edge of the recording medium P comes into contact with the nip portion between the registration roller 308 and the opposing roller in a stop condition. Then, the motor control apparatus 157 further rotates the motor 509 to rotate the pre-registration roller 327. As a result, the recording medium P is further conveyed in the conveyance direction, and the recording medium P bends.

In the above-described process, the CPU 151a controls the motor control apparatus 157 to rotate the pre-registration roller 327 by the amount corresponding to the predetermined number (m) of drive pulses after the sheet sensor 328 detects the leading edge of the recording medium P. That is, when the sheet sensor 328 detects the leading edge of the recording medium P, the CPU 151a outputs the predetermined number (m) of drive pulses to the motor control apparatus 157. The predetermined number (m) is set to a number with which the amount of bending of the recording medium P after the pre-registration roller 327 rotates by the amount corresponding to the predetermined number (m) of drive pulses after the sheet sensor 328 detects the leading edge of the recording medium P becomes the amount of bending required to suitably perform skew correction on the recording medium P. The number of drive pulses corresponding to the amount of bending required to suitably perform skew correction on the recording medium P is pre-acquired on an experimental basis. A state where a loop is formed by the bent recording medium P corresponds to a bent state.

An example of a method for stopping the rotation of the pre-registration roller 327 will be described below. Specifically, the CPU 151a outputs the same instructed phase as the last output instructed phase θ_ref to the motor control apparatus 157. Hereinafter, the CPU 151a continues outputting the same instructed phase to the motor control apparatus 157. As a result, the motor control apparatus 157 can fix the phase of the rotor 402. That is, the CPU 151a can stop the rotation of the pre-registration roller 327. The rotation of the pre-registration roller 327 may be stopped when the CPU 151a outputs an enable signal ‘L’ to the motor control apparatus 157, and the motor control apparatus 157 stops the motor 509 (for driving the pre-registration roller 327). The enable signal is a signal for enabling and disabling the operation of the motor control apparatus 157. When the enable signal is ‘L (low level)’, the CPU 151a disables the operation of the motor control apparatus 157. In other words, the CPU 151a ends the control of the motor 509 by the motor control apparatus 157. When the enable signal is ‘H (high level)’, the CPU 151a enables the operation of the motor control apparatus 157, and the motor control apparatus 157 performs the drive control of the motor 509 based on commands output from the CPU 151a.

As described above, when the sheet sensor 328 detects the leading edge of the recording medium P, and the pre-registration roller 327 rotates by the amount corresponding to the predetermined number (m) of drive pulses, the recording medium P bends. As a result, an elastic force acts on the recording medium P, and the leading edge of the recording medium P comes into contact with the nip portion between the registration roller 308 and the opposing roller. Then, skew of the recording medium P is corrected.

### <Switching Between Vector Control and Constant Current Control>

{Switching from Constant Current Control to Vector Control}

A method for switching from constant current control to vector control will be described below. As illustrated in FIG. 4, the motor control apparatus 157 according to the present embodiment is configured to switch the motor control method between constant current control and vector control. Specifically, the motor control apparatus 157 includes a control switcher 515 and a switches 516a and 516b. During the time period when constant current control is performed, a circuit for performing vector control may be operating or stopped. During the time period when vector control is performed, a circuit for performing constant current control may be operating or stopped.

As illustrated in FIG. 5, the rotation speed ω_ref′ output from the speed generator 500a is input to the control switcher 515. The control switcher 515 compares the rotation speed ω_ref′ with the threshold value ωth as a predetermined value, and, based on the comparison result, changes the motor control method from constant current control to vector control.

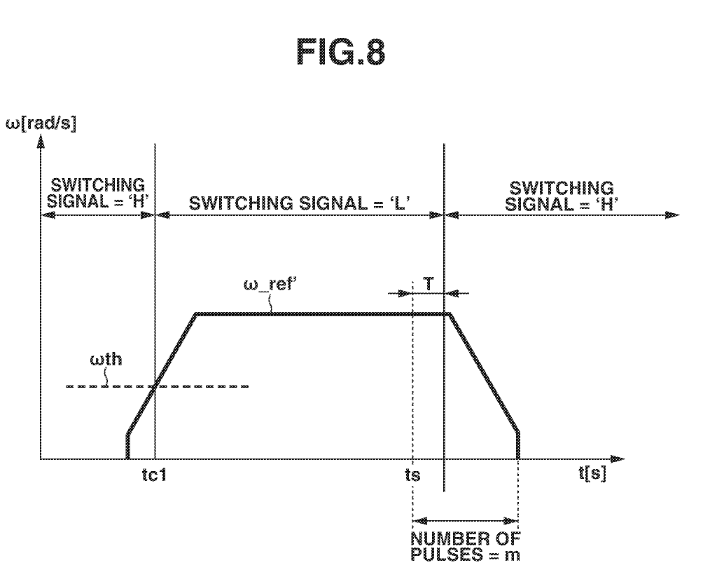

FIG. 8 illustrates switching between the motor control methods. Although the threshold value ωth is set to the lowest rotation speed out of rotation speeds with which the rotation phase θ is determined with sufficient accuracy according to the present embodiment, the present invention is not limited thereto. For example, the threshold value ωth may be set to a value equal to or larger than the lowest rotation speed out of rotation speeds with which the rotation phase θ is determined with sufficient accuracy. The threshold value ωth is prestored, for example, in a memory 515a provided in the control switcher 515.

As illustrated in FIG. 8, the control switcher 515 sets the switching signal to ‘H’ when constant current control is to be performed, and sets the switching signal to ‘L’ when vector control is to be performed. The switching signal output from the control switcher 515 is input to each switch as illustrated in FIG. 4. The control switcher 515 is outputting the switching signal, for example, at the same interval as the intervals at which the rotation speed ω_ref′ is input.

During the control by the constant-current controller 517, when the rotation speed ω_ref′ is smaller than the threshold value ωth (ω_ref′<ωth), the control switcher 515 does not switch the controller for controlling the motor 509. In other words, the control switcher 515 outputs the switching signal ‘H’ to maintain a state where the motor 509 is controlled by the constant-current controller 517. As a result, the states of the switches 516a, 516b, and 516c are maintained, and constant current control by the constant-current controller 517 is continued.

During the control by the constant-current controller 517, when the rotation speed ω_ref is equal to or larger than the threshold value ωth (ω_ref′>ωth), the control switcher 515 switches the controller for controlling the motor 509. More specifically, the control switcher 515 changes the switching signal from ‘H’ to ‘L’ and outputs the switching signal to switch the controller for controlling the motor 509 from the constant-current controller 517 to the vector controller 518. As a result, the states of the switches 516a, 516b, and 516c are changed according to the switching signal, and the vector controller 518 performs vector control. According to the present embodiment, after changing the switching signal from ‘H’ to ‘L’ and outputting the switching signal, the control switcher 515 does not compare the rotation speed ω_ref with the threshold value ωth.

{Switching from Vector Control to Constant Current Control}

A method for switching from vector control to constant current control will be described below. According to the present embodiment, a motor is controlled with high accuracy when the following configuration is applied.

As illustrated in FIG. 8, when the sheet sensor 328 detects the leading edge of the recording medium P (at time ts), the CPU 151a controls the motor control apparatus 157 to rotate the pre-registration roller 327 by the amount corresponding to the predetermined number (m) of drive pulses after the sheet sensor 328 detects the leading edge of the recording medium P and then stop the pre-registration roller 327. In other words, when the sheet sensor 328 detects the leading edge of the recording medium P, the CPU 151a outputs the predetermined number (m) of drive pulses to the motor control apparatus 157.

As illustrated in FIG. 4, the detection result of the sheet sensor 328 is also output to the control switcher 515. When the signal indicating that the sheet sensor 328 has detected the leading edge of the recording medium P is output from the sheet sensor 328, the control switcher 515 changes the switching signal from ‘L’ to ‘H’ and outputs the switching signal. More specifically, when a predetermined time period T has elapsed after the signal indicating that the sheet sensor 328 has detected the leading edge of the recording medium P is output from the sheet sensor 328, the control switcher 515 changes the switching signal from ‘L’ to ‘H’ and outputs the switching signal. As a result, the states of the switches 516a, 516b, and 516c are changed according to the switching signal, and the constant-current controller 517 performs constant current control. The predetermined time period T is preset to a time value shorter than the time period from the time ts until the rotation speed ω_ref′ starts decreasing.

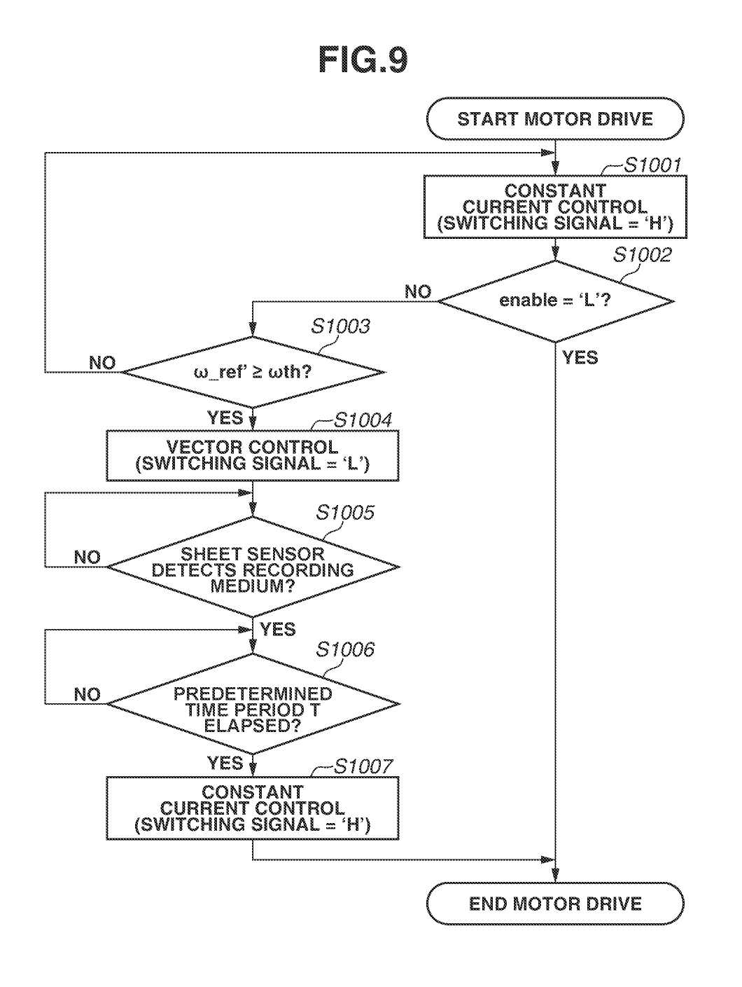

FIG. 9 is a flowchart illustrating motor control processing performed by the motor control apparatus 157. Control of the motor 509 according to the present embodiment will be described below with reference to FIG. 9. The processing in this flowchart is performed by the motor control apparatus 157 which received an instruction from the CPU 151a. FIG. 9 is described with the example of the motor control apparatus 157 being implemented in the image forming apparatus 100.

First of all, when the CPU 151a outputs the enable signal ‘H’ to the motor control apparatus 157, the motor control apparatus 157 starts the drive of the motor 509 based on commands to be output from the CPU 151a. The enable signal refers to a signal for enabling or disabling the operation of the motor control apparatus 157. When the enable signal is ‘L (low level)’, the CPU 151a disables the operation of the motor control apparatus 157. In other words, the control of the motor 509 by the motor control apparatus 157 is ended. When the enable signal is ‘H (high-level)’, the CPU 151a enables the operation of the motor control apparatus 157, and the motor control apparatus 157 controls the motor 509 based on commands to be output from the CPU 151a.

In step S1001, the control switcher 515 outputs the switching signal ‘H’ to achieve a state where the drive of the motor 509 is controlled by the constant-current controller 517. As a result, the constant-current controller 517 performs constant current control.

In step S1002, when the CPU 151a outputs the enable signal ‘L’ to the motor control apparatus 157 (YES in step S1002), the motor control apparatus 157 ends the drive of the motor 509.

On the other hand, when the CPU 151a is outputting the enable signal ‘H’ to the motor control apparatus 157 (NO in step S1002), the processing proceeds to step S1003.

In step S1003, when the rotation speed ω_ref′ is smaller than threshold value ωth (NO in step S1003), the processing returns to step S1001. In other words, the constant-current controller 517 maintains constant current control.

On the other hand, when the rotation speed ω_ref′ is equal to or larger than the threshold value ωth (YES in step S1003), the processing proceeds to step S1004. In step S1004, the control switcher 515 changes the switching signal from ‘H’ to ‘L’ and outputs the switching signal. As a result, the constant drive of motor 509 is stopped and the vector controller 518 performs vector control.

In step S1005, when the sheet sensor 328 detects the leading edge of the recording medium P (YES in step S1005), the processing proceeds to step S1006. When the sheet sensor 328 detects the leading edge of the recording medium P, the CPU 151a controls the motor control apparatus 157 to output the predetermined number (m) of drive pulses and then stop the drive of the motor 509.

In step S1006, when a predetermined time period T has elapsed after the sheet sensor 328 has detected the leading edge of a recording medium (YES in step S1006), the processing proceeds to step S1007. In step S1007, the control switcher 515 changes the switching signal from ‘L’ to ‘H’ and outputs the switching signal even when the rotation speed ω_ref′ is not smaller than the threshold value ωth. As a result, the constant-current controller 517 performs constant current control. In the above-described case where the switching signal changes from ‘L’ to ‘H’ even when the rotation speed ω_ref′ is not smaller than the threshold value ωth, if the comparison between the rotation speed ω_ref′ and the threshold value ωth is continued, the switching signal will change from ‘H’ to ‘L’ because the rotation speed ω_ref′ is equal to or larger than the threshold value ωth. This means that, immediately after the motor control method is switched from vector control to constant current control, the motor control method will be switched from constant current control to vector control. Therefore, according to the present embodiment, after the control switcher 515 changes the switching signal from ‘L’ to ‘H’ and outputs the switching signal, the control switcher 515 does not perform the comparison between the rotation speed ω_ref and the threshold value ωth.

Then, the motor control apparatus 157 stops the drive of the motor 509 in response to an instruction output from the CPU 151a. Even during vector control, in a case where the CPU 151a outputs the enable signal ‘L’ to the motor control apparatus 157, the motor control apparatus 157 stops the motor control.

As described above, according to the present embodiment, when the sheet sensor 328 detects the leading edge of the recording medium P, the CPU 151a controls the motor control apparatus 157 to drive the motor 509 by the amount corresponding to the predetermined number (m) of drive pulses and then stop the drive of the motor 509. When the sheet sensor 328 detects the leading edge of a recording medium P during execution of vector control, the control switcher 515 switches the motor control method from vector control to constant current control after the predetermined time period T has elapsed since the detection. The predetermined time period T is preset to a time value shorter than the time period from the time ts until the rotation speed ω_ref′ starts decreasing. More specifically, according to the present embodiment, the motor control method is switched from vector control to constant current control while the motor 509 is being driven at a predetermined speed (constant speed), not during deceleration of the motor 509. This can prevent the rotation phase at which the rotor is stopped from leading the phase at which the rotor needs to be stopped. That is, the motor control can be performed with high accuracy.

Although, in the present embodiment, the motor control method is switched from vector control to constant current control after the predetermined time period T has elapsed after the sheet sensor 328 has detected the leading edge of the recording medium P, the present invention is not limited thereto. For example, the motor control method may be switched from vector control to constant current control when the sheet sensor 328 detects the leading edge of the recording medium P.

Although, in the present embodiment, the predetermined time period T is preset to a time value shorter than the time period from the time ts until the rotation speed ω_ref′ starts decreasing (until the deceleration operation is started), the present invention is not limited thereto. For example, the predetermined time period T may be set to a time value so that the deviation between the instructed phase θ_ref and the rotation phase θ when the predetermined time period T has elapsed since the time ts is smaller than the value corresponding to an electrical angle of 360 degrees. In other words, the motor control method may be switched from vector control to constant current control at a predetermined timing before the deviation between the instructed phase θ_ref and the rotation phase θ in the time period during which the rotor is being subjected to the deceleration control becomes equal to or larger than the value corresponding to an electrical angle of 360 degrees. This can prevent the rotation phase at which the rotor is stopped from leading the phase at which the rotor needs to be stopped. That is, the motor control can be performed with high accuracy.

The motor control method may not be switched from vector control to constant current control based on the detection result of the sheet sensor 328. For example, the motor control method may be switched from vector control to constant current control when a predetermined time period T2 has elapsed after the motor drive is started. The predetermined time period T2 is preset to a time value which is shorter than the time period after the motor drive is started until the rotation speed ω_ref′ starts decreasing and is longer than the time period after the motor drive is started until the motor control method is switched from constant current control to vector control.

For example, the motor control method may be switched from vector control to constant current control when a predetermined number (M) of drive pulses is output from the CPU 151a. The predetermined number (M) is set to a value smaller than the number of drive pulses corresponding to the time period from the drive pulse output is started until the rotation speed ω_ref′ starts decreasing. The predetermined number (M) is preset to a value larger than the number of drive pulses corresponding to the time period after the drive pulse output is started until the motor control method is switched from constant current control to vector control.

For example, the CPU 151a may output an instruction for switching the motor control from vector control to constant current control to the control switcher 515, and, in response to the command, the control switcher 515 may switch the motor control method from vector control to constant current control.

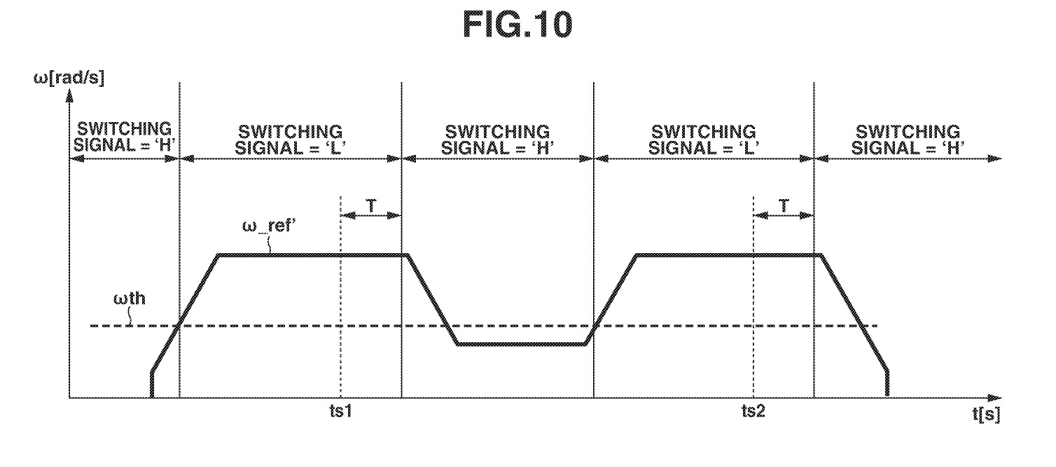

Although, in the above-described operation sequence according to the present embodiment, the motor is accelerated, driven at a constant speed, decelerated, and then stopped, as illustrated in FIG. 8, the present invention is not limited thereto. For example, as illustrated in FIG. 10, the present embodiment is also applied to an operation sequence in which the motor is accelerated, driven at a first speed, decelerated, driven at a second speed lower than the first speed, accelerated, and then driven at the first speed again. In a case where the present embodiment is applied to the operation sequence illustrated in FIG. 10, the control switcher 515 resumes the comparison between the rotation speed ω_ref′ and the threshold value ωth, for example, when the rotation speed ω_ref′ reaches a constant speed (second speed).

The present embodiment is applied not only to the motor 509 for driving the pre-registration roller 327 but also to a motor for driving a load provided in the image forming apparatus 100.

Although, in the present embodiment, the speed generator 500a generates the rotation speed ω_ref′ based on the time interval between falling edges of continuous drive pulses, the present invention is not limited thereto. For example, the CPU 151a may generate the rotation speed ω_ref′ and output the rotation speed ω_ref′ to the control switcher 515 at predetermined time intervals.

According to the present embodiment, a circuit for controlling the drive of the motor 509 using the vector controller 518 is equivalent to a first control circuit according to the present invention. Further, according to the present embodiment, a circuit for controlling the drive of the motor 509 using the constant-current controller 517 is equivalent to a second control circuit according to the present invention.

Although, in the present embodiment, a 2-phase stepping motor is used as a motor for driving a load, the present embodiment is also applicable to a 3-phase stepping motor and stepping motors with more than three phases.

Although, in the present embodiment, skew correction is performed on the recording medium P when the leading edge of the recording medium P comes into contact with the nip portion between the registration roller 308 as a contact member and the opposing roller, the present invention is not limited thereto. For example, a shutter, as a contact member which the leading edge of the recording medium P contacts, is disposed on the upstream side of the registration roller 308 and on the downstream side of the sheet sensor 328, or disposed on the upstream side of the transfer position and on the downstream side of the registration roller 308 in the recording medium conveyance direction. When the leading edge of the recording medium P comes in contact with the shutter, skew correction is performed on the recording medium using the above-described method. Then, the shutter may be retracted when the registration roller 308 conveys the recording medium P to the transfer position in synchronization with the timing of the toner image.

Although, in the present embodiment, a permanent magnet is used as the rotor, the rotor is not limited thereto.

According to the present invention, the motor control can be performed with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-074965, filed Apr. 9, 2018, which is hereby incorporated by reference herein in its entirety.

What is claimed is:

1. A motor control apparatus for controlling a motor based on an instructed phase indicating a target phase of a rotor of the motor, the motor control apparatus comprising:
a detector (508) configured to detect a drive current flowing in a winding of the motor;
a phase determiner (513) configured to determine a rotation phase of the rotor based on the drive current detected by the detector; and
a controller configured to control the motor according to a first control mode in which a drive current flowing in the winding of the motor is controlled to reduce a deviation between the instructed phase and the rotation phase determined by the phase determiner, and configured to control the motor according to a second control mode in which the motor is controlled based on a current having a predetermined magnitude,
wherein the controller is configured to change a control mode from the first control mode to the second control mode in the case that the rotor is rotated in the first control mode at a predetermined speed and configured to decelerate the speed of the rotor after said change of control mode.

2. The motor control apparatus according to claim 1, further comprising a generator for generating a predetermined number of pulses in a time period from a predetermined timing after drive of the motor is started until the drive of the motor is stopped,
wherein the first control mode is a control mode for controlling the motor by controlling the drive current flowing in the winding of the motor so as to reduce the deviation between an instructed phase based on the pulses generated by the generator and the rotation phase determined by the phase determiner.

3. The motor control apparatus according to claim 2,
wherein, when a value corresponding to a frequency of a pulse train including the pulses output from the generator changes from a value smaller than a predetermined value to a value larger than the predetermined value in the second control mode, the controller is configured to change the control mode from the second control mode to the first control mode, and
wherein a frequency of pulses that corresponds to the predetermined speed is larger than the predetermined value.

4. The motor control apparatus according to claim 3,
further comprising an induced voltage determiner (512) configured to determine magnitudes of induced voltages induced in a first phase winding and a second phase winding by the rotation of the rotor,
wherein the phase determiner (513) determines the rotation phase of the rotor based on the magnitudes of the induced voltages for the first and the second phases determined by the induced voltage determiner, and
wherein the predetermined value is set to a rotation speed at which the phase determiner can determine the rotation phase of the rotor of the motor based on the magnitudes of the induced voltages for the first and the second phases determined by the induced voltage determiner.

5. The motor control apparatus according to claim 3, wherein, when the control mode is changed from the first control mode to the second control mode, the controller is configured not to perform a comparison between the value corresponding to the frequency of the pulse train and the predetermined value.

6. The motor control apparatus according to claim 1, wherein the motor is a stepping motor.

7. The motor control apparatus according to claim 1, further comprising a instruction generator (500) configured to update the instructed phase by adding a predetermined variation to the instructed phase each time the pulses are output from the generator.

8. The motor control apparatus according to claim 1, wherein, in the first control mode, the motor control apparatus is configured to control the motor by controlling the drive current based on a torque current component as a current component represented in a rotating coordinate system based on the rotation phase determined by the phase determiner, and as a current component for generating torque in the rotor.

9. The motor control apparatus according to claim 1, further comprising:
a first control circuit configured to supply drive currents to a first phase winding and a second phase winding of the motor in a case where the first control mode is performed;
a second control circuit configured to supply drive currents to a first phase winding and a second phase winding of the motor in a case where the second control mode is performed; and
a switcher configured to switch between controlling the motor by using the first control circuit and controlling the motor by using the second control circuit.

10. A motor control apparatus for controlling a motor based on an instructed phase indicating a target phase of a rotor of the motor, the motor control apparatus comprising:
a detector (508) configured to detect a drive current flowing in a winding of the motor;
a phase determiner (513) configured to determine a rotation phase of the rotor based on the drive current detected by the detectors; and
a controller (518) configure to control the motor according to a first control mode in which a drive current flowing in the winding of the motor is controlled to reduce a deviation between the instructed phase and the rotation phase determined by the phase determiner, and configured to control the motor according to a second control mode in which the motor is controlled based on a current having a predetermined magnitude,
wherein, the controller is configured to change the control mode from the first control mode to the second control mode at a predetermined timing before the deviation becomes equal to or larger than a value corresponding to an electrical angle of 360 degrees in a time period during which the first control mode is performed and the rotor is being decelerated.

11. A sheet conveyance apparatus comprising:
a conveyance roller (306) configured to convey a sheet;
a motor (509) configured to drive the conveyance roller:
a detector (508) configured to detect a drive current flowing in a winding of the motor;
a phase determiner (513) configured to determine a rotation phase of the rotor based on the drive current detected by the detectors; and
a controller configured to control the motor according to a first control mode in which a drive current flowing in the winding of the motor is controlled to reduce a deviation between an instructed phase indicating a target phase for the rotor and the rotation phase determined by the phase determiner, and configured to control the motor according to a second control mode in which the motor is controlled based on a current having a predetermined magnitude,
wherein the controller is configured to change a control mode from the first control mode to the second control mode in the case that the rotor is rotated in the first control mode at a predetermined speed and configured to decelerate the speed of the rotor after said change of control mode.

12. The sheet conveyance apparatus according to claim 11, further comprising:
a contact member disposed on a downstream side of the conveyance roller in a conveyance direction in which the sheet is conveyed, and configured to contact the leading edge of the sheet conveyed by the conveyance roller; and
a sheet detector disposed on an upstream side of the contact member in the conveyance direction, and configured to detect the sheet,
wherein, when the sheet detector detects the leading edge of the sheet, the controller switches the control mode from the first control mode to the second control mode and decelerates the rotor after the control mode is switched from the first control mode to the second control mode.

13. The sheet conveyance apparatus according to claim 12, wherein the contact member is a second conveyance roller for conveying the sheet in a bent state in the conveyance direction.

14. A document feeding apparatus comprising:
a document stacking unit (203) configured to hold a document;
a conveyance roller (306) configured to convey the document;
a motor (509) configured to drive a load;
a detector (508) configured to detect a drive current flowing in a winding of the motor;
a phase determiner (513) configured to determine a rotation phase of the rotor based on the drive current detected by the detectors; and
a controller configured to control the motor according to a first control mode in which a drive current flowing in the winding of the motor is controlled to reduce a deviation between an instructed phase indicating a target phase for the rotor and the rotation phase determined by the phase determiner, and configured to control the motor according to a second control mode in which the motor is controlled based on a current having a predetermined magnitude,
wherein the controller is configured to change a control mode from the first control mode to the second control mode in the case that the rotor is rotated in the first control mode at a predetermined speed and configured to decelerate the speed of the rotor after said change of control mode.

15. A document reading apparatus comprising:
a document stacking unit (203) configured to hold a document;
a conveyance roller (306) configured to convey a document;
a reading unit (111) configured to read the document conveyed by the conveyance roller;
a motor (509) configured to drive a load;
a detector (508) configured to detect a drive current flowing in a winding of the motor;
a phase determiner (513) configured to determine a rotation phase of the rotor based on the drive current detected by the detectors; and
a controller configured to control the motor according to a first control mode in which a drive current flowing in the winding of the motor is controlled to reduce a deviation between an instructed phase indicating a target phase for the rotor and the rotation phase determined by the phase determiner, and configured to control the motor according to a second control mode in which the motor is controlled based on a current having a predetermined magnitude,
wherein the controller is configured to change a control mode from the first control mode to the second control mode in the case that the rotor is rotated in the first control mode at a predetermined speed and configured to decelerate the speed of the rotor after said change of control.

16. An image forming apparatus comprising:
an image forming unit configured to form an image on a recording medium;
a motor (509) configured to drive a load;
a detector (508) configured to detect a drive current flowing in a winding of the motor;
a phase determiner (513) configured to determine a rotation phase of the rotor based on the drive current detected by the detectors; and
a controller configured to control the motor according to a first control mode in which a drive current flowing in the winding of the motor is controlled to reduce a deviation between an instructed phase indicating a target phase for the rotor and the rotation phase determined by the phase determiner, and configured to control the motor according to a second control mode in which the motor is controlled based on a current having a predetermined magnitude,
wherein the controller is configured to change a control mode from the first control mode to the second control mode in the case that the rotor is rotated in the first control mode at a predetermined speed and configured to decelerate the speed of the rotor after said change of control mode.

17. The image forming apparatus according to claim 16, wherein the load is a conveyance roller for conveying the recording medium.
